(19) United States
(12) Patent Application Publication
(10) Pub. No.: US 2026/0277839 A1
(43) Pub. Date: Sep. 17, 2026

(54) INTERCONNECT METHOD FOR MEMORY EXPANSION, SCALE-UP AND SCALE-OUT OF AI/ML SYSTEMS

(71) Applicant: Huawei Technologies Co., Ltd., Shenzhen (CN)

(72) Inventors: Hamid Mehrvar, Ottawa (CA); Eric Bernier, Kanata (CA); Yueqi Liang, Kanata (CA)

(21) Appl. No.: 19/077,739

(22) Filed: Mar. 12, 2025

(51) Int. Cl. G06F 13/40; G06F 9/54

(52) U.S. Cl. CPC G06F 13/4022; G06F 9/54; G06F 2209/543

(57) ABSTRACT

Interconnect systems and methods for processors are provided. A described interconnect system includes a plurality of switches, each of the plurality of switches having a first interface coupled to a respective one of a plurality of I/O interfaces of a processor, and N second interfaces providing selective connectivity between the first interface and N external connections. Some interconnect systems further include plurality of scale-out switches providing selective connectivity between the processor and N planes of inter-rack switching, and an inter-rack switch cluster including the N planes of inter-rack switching. Each plane provides interconnectivity between the processor other processors provided on other racks.

### TECHNICAL FIELD

The present disclosure generally relates to artificial intelligence (AI) and machine learning (ML) systems, and more specifically to systems and methods to increase processor interconnectivity for AI/ML computing tasks.

### BACKGROUND

Growth of Large language models (LLMs), commonly referred broadly as generative AI, has resulted in an increase in size of the data sets that are used in the model training applications. The number of parameters used in these generative AI architectures has been doubling every 4 months whereas the capacity of the compute components is doubling every 24 months. The disparity between these two growth rates has necessitated the use of more compute chips for training applications, and as a result requires interconnect technology to allow connectivity among these chips.

Given throughput of a processor, as well as the rate of its interface are limited, it is desirable to increase connectivity to/from a processor so that it could interconnect to many other processors or memories, whether they are on the same board, in the same rack, or in the other racks. However, due to physical limitations processors can have limited interfaces for interconnecting to the other components. Given the scarce interconnect capacity and given the requirement to interconnect with more and more chips, there is a need for not only scaling interconnectivity to many chips but also for versatile and fault-tolerant interconnection that offers flexibility and fault recovery.

### SUMMARY

In the present disclosure, systems and methods for interconnecting processors to other components are described. Broadly speaking, one or many 1×N switches coupled to an interconnect interface of a processor are provided. Different embodiments of this disclosure are described in which the design of the 1×N switch varies according to the use-case and the intended application.

Three general use-cases are described. In a first use-case, chip-to-chip board-level interconnection is described. In this use case, a plurality of 1×N switches coupled to an interconnect interface of a processor on an integrated circuit (IC) board provide interconnection between the processor and other components that are also provided on the IC board.

In a second use-case, intra-rack (or intra-chassis) interconnection is described. In this use case, the plurality of 1×N switches provide interconnection between the processor and other components that are provided on the same IC board as the processor and/or other components on different IC boards. The different IC boards can be provided in different slots of the same rack or chassis.

In a third use-case, inter-rack (or inter-chassis) connectivity is described. In this use case, in addition to the plurality of 1×N switches of the previous use cases, at least one of the interconnect interfaces of the processor is coupled to a 1×N switch that provides scale-out connectivity. The scale-out connectivity allows the processor to connect to components that are provided on a rack or chassis that is different from the processor's rack or chassis.

In contrast to existing systems that use N×N switches for interconnectivity, the present disclosure provides for a plurality of 1×N switches that are coupled to input/output (I/O) interfaces of a processor. This configuration can provide several advantages. One advantage is scaling at many levels, as the switch configuration allows scaling processor-to-processor connectivity both at intra-rack and inter-rack levels. Another advantage is fault-tolerance. At board level, the switch configuration allows replacing a dead memory, for instance, with an extension memory. A further advantage is flexibility. As each I/O is coupled to 1×N switch in both directions, this configuration allows a processor to connect many other devices such as external cards, external memory, or other processors on-demand. Finally, use of 1×N switches for inter-rack connectivity can provide expedited connections through a core cluster of switches that are otherwise slow.

In a first aspect, an interconnect system for a processor including a plurality of input/output (I/O) interfaces is provided. The interconnect system includes a plurality of switches, each of the plurality of switches having a first interface coupled to one of the plurality of I/O interfaces and N second interfaces providing selective connectivity between the first interface and N external connections.

In some implementations, the plurality of switches includes: a plurality of 1×N switches each providing connectivity in a transmit direction between one output interface of the processor and the N external connections; and a plurality of N×1 switches each providing connectivity in a receive direction between the N external connections and one input interface of the processor.

In some implementations, the plurality of I/O interfaces each include an array of I channels, further wherein the plurality of switches is operable to switch all I channels of the first I/O interface to I corresponding channels of a selected one of the N external connections.

In some implementations, at least one of the plurality of switches is a copper-based lane switch, a multi-mode fiber-based switch, or a single mode fiber-based switch. In some implementations, the plurality of switches is bi-directional providing connectivity in both a transmit direction and a receive direction between the one of the plurality of I/O interfaces and the N external connections.

In some implementations, the N external connections include connections to components external to the processor including at least one of: memory modules, other processors, and switches coupled to memory modules and/or other processors.

In some implementations, the processor is provided on an integrated circuit (IC) board, and at least some of the external components are also provided on the IC board. The processor can be provided on a first IC board, and at least some of the external components can be provided on one or more second IC boards. The first IC board can be provided in a first slot of a rack, and the one or more second IC boards can be provided in respective second slots of the rack.

In some implementations, the processor is provided on an IC board, and the plurality of switches are also provided on the IC board. The IC board can be provided in a first slot of a rack, and the N external connections can include connections to external components in respective second slots of the rack.

In some implementations, the processor is provided on a first IC board, and the plurality of switches are provided on one or more second IC boards. The first IC board can be provided in a first slot of a rack, and the one or more second IC boards can be provided in respective second slots of the rack.

In some implementations, the processor is provided in a first rack, the interconnect system includes at least one scale-out switch having a first interface coupled to one of the plurality of I/O interfaces and a plurality of second interfaces providing selective connectivity between the first interface and a plurality of inter-rack switches, the plurality of inter-rack switches providing connectivity to components in one or more second racks.

According to an aspect, an interconnect system for a plurality of processors provided on M racks is provided. The interconnect system includes: a plurality of scale-out switches, each scale-out switch having a first interface coupled to an I/O interface of one of the plurality of processors and N second interfaces providing selective connectivity to N planes of inter-rack switching; and an inter-rack switch cluster including the N planes of inter-rack switching, each plane including a plurality of inter-rack switches, each inter-rack switch including M first interfaces and M second interfaces each coupled to a scale-out switch of a processor on a respective one of the M racks.

In some implementations, each rack has a capacity of L processors, and each plane of the inter-rack switching includes L inter-rack switches.

In some implementations, the plurality of scale-out switches are fast photonic switches, and the plurality of inter-rack switches are slow optical circuit (OCS) switches.

In some implementations, N is greater than or equal to 2.

According to an aspect, a method is provided for establishing a connection between a first processor provided on a first rack and a second processor provided on a second rack via an inter-rack switch cluster including N planes of inter-rack switching. The method includes: operating an inter-rack switch in one of the N planes to preestablish a connection path between the first processor and the second processor; and once the connection path has stabilized, operating a scale-out switch coupled to the first processor to connect the first processor to the connection path in the one of the N planes.

### BRIEF DESCRIPTION OF THE DRAWINGS

For a better understanding of the implementations described herein and to show more clearly how they may be carried into effect, reference will now be made, by way of example only, to the accompanying drawings which show at least one exemplary implementation.

FIG. 1 is a block diagram of an exemplary processor having I/O interfaces for providing connectivity to other components, according to an embodiment.

FIG. 2 is a schematic illustrating an interconnect system for the processor of FIG. 1, in accordance with an exemplary embodiment.

FIG. 3 is a schematic illustrating an interconnect system for the processor of FIG. 1, in accordance with another exemplary embodiment.

FIG. 4 is a schematic illustrating interconnectivity between the processor and external components provided on the same IC board, in accordance with an embodiment.

FIGS. 5A and 5B are schematics illustrating intra-rack connectivity of a processor in accordance with an exemplary embodiment in which switches are provided on the same IC board as processor.

FIGS. 6A and 6B are schematics illustrating intra-rack connectivity of a processor in accordance with another exemplary embodiment in which switches are provided on dedicated switch cards.

FIG. 7 is a schematic illustrating an interconnect system for the processor of FIG. 1, in accordance with another exemplary embodiment in which inter-rack switching is provided.

FIG. 8 is a schematic illustrating an interconnect system in accordance with an exemplary embodiment in which interconnectivity to a plurality of processors on a plurality of racks is provided.

FIG. 9 is a schematic illustrating an exemplary method for establishing a connection between a first processor and a second processor using the interconnect system of FIG. 8.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary implementations described herein. However, it will be understood by those of ordinary skill in the art that the implementations described herein may be practiced without these specific details. In other instances, well-known methods, procedures and components have not been described in detail so as not to obscure the implementations described herein. Furthermore, this description is not to be considered as limiting the scope of the implementations described herein in any way but rather as merely describing the implementation of the various implementations described herein.

In the present disclosure, “at least one” means one or more, and “a plurality of” means two or more. The expression “and/or” describes an association relationship of associated objects, and indicates that there may be three relationships. For example, “A and/or B” includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, all three of “at least one of a, b, or c”, “at least one of a, b, and c” and “at least one of a, b, and/or c” may represent “a”, “b”, “c”, “a and b”, “a and c”, “b and c”, or “a, b and c”, where a, b, and c may be a single or multiple form.

In the following description, an implementation is an example or a possible embodiment. The various appearances of “one implementation”, “an implementation” or “some implementations” do not necessarily all refer to the same implementations. Although various features may be described in the context of a single implementation, the features may also be provided separately or in any suitable combination. Conversely, although this disclosure may be described herein in the context of separate implementations for clarity, it may also be implemented in a single implementation. Reference in the specification to “some implementations”, “an implementation”, “one implementation” or “other implementations” means that a particular feature, structure, or characteristic described in connection with the implementations is included in at least some implementations, but not necessarily all implementations.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in implementations other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference does not mean that there is only one of that element. It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which this disclosure belongs, unless otherwise defined. It will be appreciated that the methods described herein may be performed in the described order, or in any suitable order.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof. When an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the following description, systems and methods will be described that allow interconnection of processors to other components using 1×N switches that are coupled to interfaces of the processor. Different configurations of the 1×N switch will be described in accordance with different embodiments.

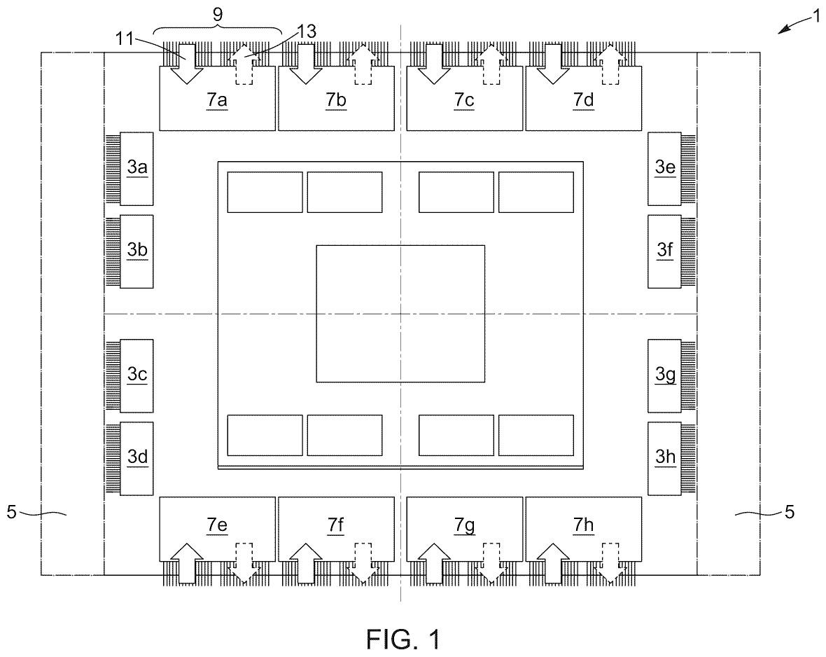

With reference to FIG. 1, an exemplary processor 1 is shown according to an embodiment. The illustrated processor is a graphics processing unit (GPU), but it is appreciated that the systems and methods described herein can be used to interconnect other types of processors, such as one or more of a central processing unit (CPU), a field programmable gate array (FPGA), an application-specific integrated circuit (ASIC), or any other unit capable of performing processing tasks. The processor 1 comprises a plurality of memory interfaces 3 that provide connection to a plurality of dedicated high-bandwidth memory (HBM) modules 5. In the present embodiment, eight memory interfaces 3a-3h are provided, but it is appreciated that other configurations are possible.

The processor 1 further comprises a plurality of input/output (I/O) interfaces 7 for providing connectivity to other components. In the present embodiment, eight I/O interfaces 7a-7h are provided, allowing interconnectivity with eight external components. It is appreciated, however, that in other embodiments, a different number of I/O interfaces can be provided. Each I/O interface 7 comprises a plurality I of lanes or channels 9. In the present embodiment, each I/O interface 7 comprises I=256 channels, providing a 256-channel input interface 11 in the receive (Rx) direction, and a 256-channel output interface 13 in the transmit (Tx) direction. As can be appreciated, different channel configurations are possible that can provide different I/O bandwidth. In the present embodiment, each I/O interface 7 is configured as a copper-based or electrical link, which can be operated at a given speed, such as 56 GHz, 112 GHz or 22 GHz or higher. It is appreciated that other types of interfaces are possible. For example, in some embodiments the interface can be an optical interface, for example providing interconnectivity via single-mode or multi-mode fibers. In some embodiments, all the I/O interfaces 7 can be of the same type (e.g., all copper-based), whereas in other embodiments the I/O interfaces 7 can comprise a mix of different type of interfaces (e.g., some copper-based interfaces and some optical interfaces).

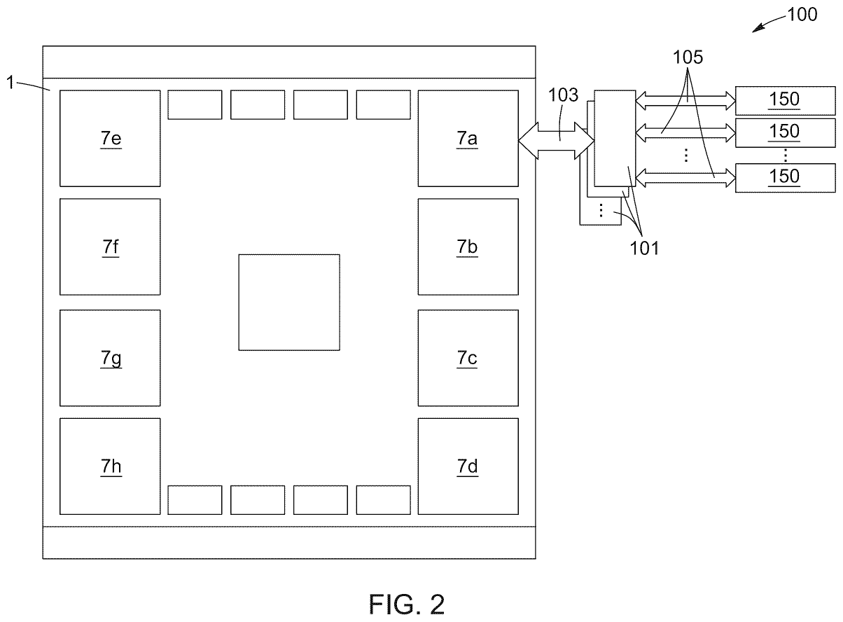

With further reference to FIG. 2, an interconnect system 100 for the processor 1 is shown according to an exemplary embodiment. The interconnect system 100 comprises a plurality of switches 101, with each switch 101 being operable to provide selective connectivity between an I/O interface 7 of the processor 1 and a plurality of external connections 150. In the present embodiment, the illustrated plurality of switches 101 provide selective connectivity to a first I/O interface 7a, but it is appreciated that further pluralities of switches can provide selective connectivity to each of the remaining I/O interfaces 7b-7h. Each of the plurality of switches 101 has one first interface 103 coupled to a respective one of the plurality of I/O interfaces 7 of the processor 1, and N second interfaces 105 providing selective connectivity between the first interface 103 and N external connections 150. It is appreciated that the number N of second interfaces 105 can be scaled depending on the number of external connections 150 that are required. The external connections 150 correspond to connections to any component that is external to the processor 1, and can comprise connections to external components such as external memory modules, other processors, etc. The connection to external components can be direct, or indirect, for example via a connection to a switch which is itself coupled to one or more external memory modules, other processors, etc.

The switches 101 are provided in a 1×N configuration, where the first interface 103 can be referred to as the switch input (represented as 1 in the 1×N notation), and the second interface 105 can be referred to as the switch outputs (represented as the N in the 1×N notation). The switches implement a switching function whereby they can be operated to connect the switch input to any one of the N outputs. As can be appreciated, the switch input can comprise an array of J channels, and each switch output can also comprise a corresponding array of J channels. The switching function of the switches 101 can perform a connection from the array of all J channels of the switch input to the array of all J channels of any of the N outputs at once and in parallel. In the present embodiment, eight switches 101 are provided, with the input and output of each switch having an array of J=32 channels. In this fashion, the processor I/O interface 7a having a bandwidth of 256 channels can be switched to N outputs each with 256 channels using the eight 1×N switches, with each switch input and output servicing 32 of the 256 channels. Switching all eight switches in parallel can allow all 256 channels (8×32) to be switched at once. As can be appreciated, the switches 101 can be bi-directional, such that they can handle switching 256 Tx channels and 256 Rx channels. As can be further appreciated, eight switches can be provided for each I/O interface 7a-7h to allow selective switching of all 256 Tx/Rx channels of each I/O interface 7a-7h.

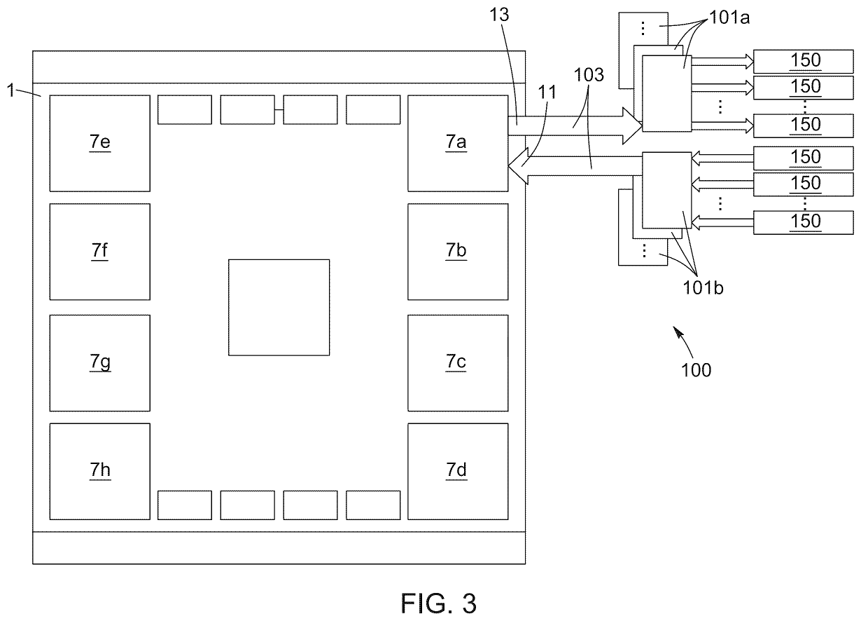

Although in the present embodiment eight switches 101 are provided for each I/O interface 7, it is appreciated that a different configuration of switches is possible. For example, instead of dividing 256 channels among eight switches (with each input/output of a switch covering 32 channels), 16 parallel switches can be provided with input/outputs covering 16 channels, for the same purpose of switching 256 channels. As another example, and as illustrated in FIG. 3, the switches 101 can be uni-directional, and separate sets of switches can be provided in the transmit direction and the receive direction of the I/O interfaces 7. In particular, the plurality of switches 101 can comprise a plurality of 1×N switches 101a each providing connectivity in a transmit direction between an output interface 13 of a processor I/O interface 7 and the N external connections (e.g., to transmit data from an I/O interface 7 to one of the external connections 150), and a plurality of N×1 switches 101b each providing connectivity in a receive direction between the N external connections and an input interface 11 of the processor I/O interface 7 (e.g., to receive data at the I/O interface 7 from one of the external connections 150). In the illustrated embodiment, eight 1×N switches 101a are provided to allow selective connectivity between I/O interface 7a and N external connections 150 in the transmit direction, and eight N×1 switches 101b are provided to allow selective connectivity between the N external connections 150 and the I/O interface 7a in the receive direction. It is appreciated that a similar configuration of switches can be provided for the remaining I/O interfaces 7b-7h. As yet a further example, it is appreciated that the overall number of switches can vary depending on how many I/O interfaces 7 of the processor 1 require switching connectivity.

In the present embodiment, the switches 101 are copper-based for switching the copper-based channels of the I/O interfaces 7. More specifically, the switches 101 are configured in a bus configuration along with a miniature set of cross-bar switches to allow connectivity of an input to any of the N outputs on the transmit direction or, conversely, connectivity of any of the N inputs to the output in the receive direction. These switches can, for example, be lane switch (copper-based) running at 112 GHz or 224 GHz.

As can be appreciated, different types of switches 101 can be provided depending on the configuration of the I/O interfaces 7. In an embodiment at least one of the I/O interfaces 7 can comprise parallel multi-mode fibers, for example VCSEL, vertical-cavity surface-emitting laser, with multi-mode fiber. In such a configuration at least one of the plurality of switches can be a multi-mode fiber-based switch. In an embodiment, at least one of the I/O interfaces 7 can comprise one or more single-mode fibers. In such a configuration at least one of the plurality of switches can be a single-mode fiber-based switch. For example, the switch can be configured with fiber-based connections using wavelength division multiplexing (WDM) such as dense wavelength division multiplexing (DWDM) at C-or L-band with 4 or 8 or higher number of wavelengths and, hence, reduction in number of fibers. In embodiments where the switches 101 comprise optical switches, the switches can operate in a bi-directional mode for example by using one or many first wavelengths in the Tx direction, and by using one or many non-overlapping second wavelengths in the Rx direction over the same fiber. In this fashion, concurrent Tx/Rx in both directions can be achieved.

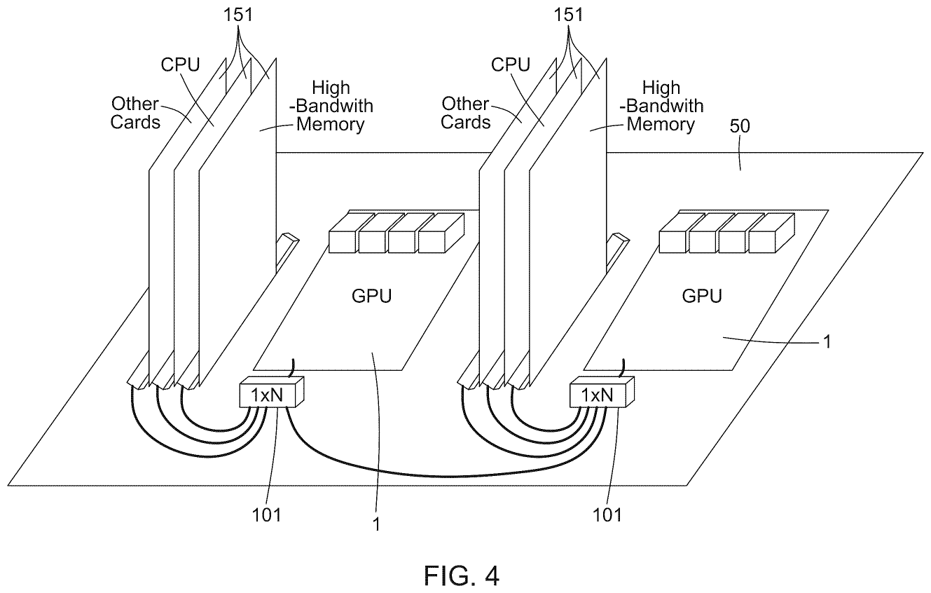

In some embodiments, the interconnect system 100 described above can be configured to provide board-level chip-to-chip interconnection. For example, with reference to FIG. 4, processors 1 are provided on an integrated circuit (IC) board 50, and the switches 101 on the IC board 50 provide interconnectivity between the processors 1 and/or between the processors 1 and external components 151 that are also provided on the IC board 50. As can be appreciated, this configuration can provide an advantage in permitting versatility in interconnecting various board-level components on a per need basis. This configuration can provide a further advantage of fault-tolerance and fault isolation by allowing a faulty component (e.g., an attached HBM memory) to be disconnected and replaced with another component (e.g., another external on-board memory).

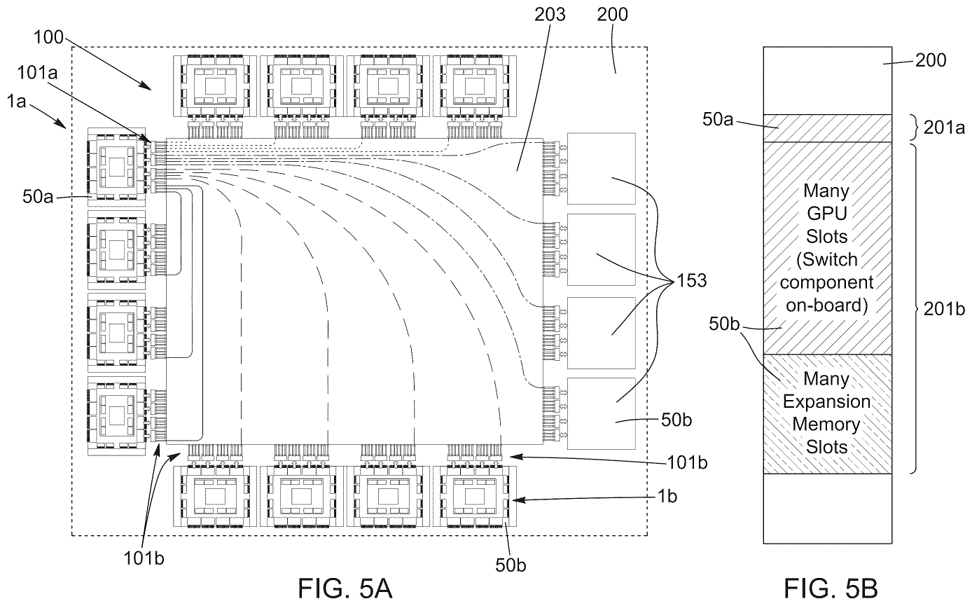

In some embodiments, the interconnect system 100 described above can be configured to provide intra-rack or intra-chassis connectivity. With reference to FIGS. 5A and 5B, a first processor 1a can be provided on a first IC board 50a residing in a first slot 201a of a rack or chassis 200, and the interconnect system 100 provides connectivity to external components provided in respective second slots 201b of the rack or chassis via switches 101. In the present embodiment, the external components comprise a plurality of second processors 1b and a plurality of external memory modules 153 each provided on one of a plurality of second IC boards 50b that reside in the second slots 201b, but it is appreciated that other configurations are possible.

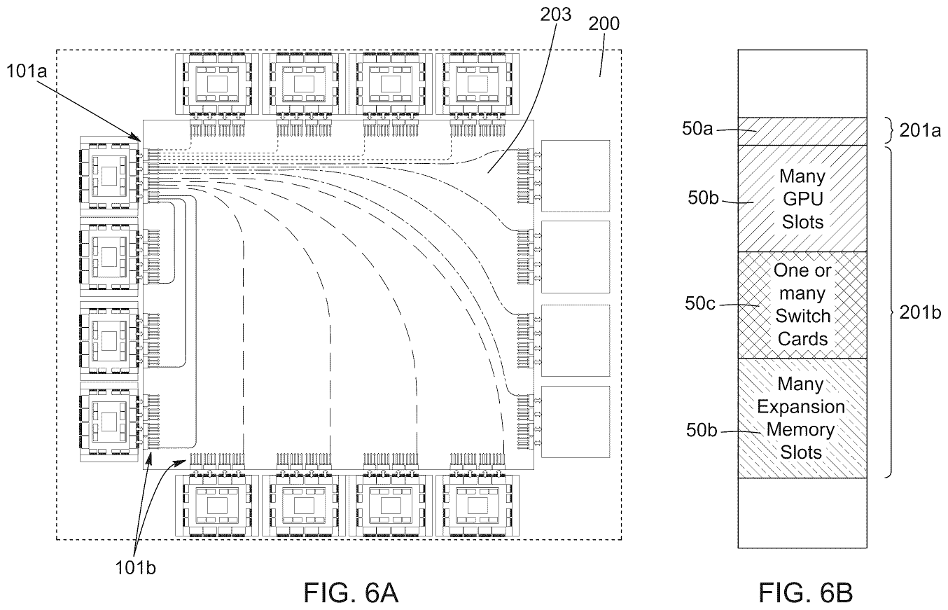

Connectivity between the processor 1a and external components can be achieved via different configurations of switches 101. In the embodiment illustrated in FIGS. 5A and 5B, first switches 101a are provided on the same IC board 50a as first processor 1a. Similarly, second switches 101b are also provided on the same IC board 50b as the external components. The input/output of the switches 101 are coupled through connections that run through a backplane 203 of the rack or chassis. For example, outputs of the first switches 101a can be connected directly to respective inputs of the second switches 101b. This can be achieved by a cable or fibers running through the backplane 203. In this configuration, the switches 101 are distributed among the cards/boards 50 on which the processors 1 and/or external components reside, and there are no dedicated switch cards that occupy second slots 201b in the rack 200. This can maximize the number of available second slots 201b that can be occupied by boards 50b housing external components. It is appreciated, however, that other configurations are possible. For example, as illustrated in FIGS. 6A and 6B, the plurality of switches 101 can be provided on one or more separate IC boards 50c (e.g., switch cards) that reside in the one or more of the second slots 201b.

Different connection mechanisms for achieving the connection between IC boards 50a, 50b are possible depending on the configuration of the I/O interfaces and/or the configuration of switches 101. In an embodiment, the switches 101 are copper-based, irrespective of whether the switch is distributed among all the boards (according to the embodiment of FIGS. 5A and 5B) and these switches are inter-connected through a copper wire backplane, or the switch is centralized (according to the embodiment of FIGS. 6A and 6B), where all the switches occupy slots in a rack and these switches are coupled to their respective I/O of a processor. The speed that the wire/copper-based switches can operate can be 56 GHz or 112 GHz or 224 GHz, where a large number of parallel lanes at the input of a switch could be connected to one of the N outputs of the switch with each output is a large number of parallel copper lanes. For instance, for an I/O rate of 1.6 TB/s (or 12.8 Tb/s) one can assume a rate of 50 Gb/s per lane with 256 lanes that could be arranged in a 16×16 matrix. Alternately the arrangement could be a matrix of 8×8 if the data rate per lane is 200 Gbps (or 224 GHz).

In an embodiment, the switches 101 are multi-mode fiber switches. The multi-mode fiber-based connections can use different schemes, including two standards for 800 G. One example is SR8 transceivers based on VCSEL scheme at 850 nm and a single channel rate of 100 Gbps PAM4 . This requires 16 optical fibers, 8 for transmit and 8 for receive. Another example is SR4.2 that uses two wavelengths of 850 nm and 910 nm for bi-directional transmission. This uses 4 fibers for Rx and 4 fibers for Tx, with transmission on two wavelengths on each fiber.

In some embodiments, the multi-mode fiber switch can be VCSEL-based electro-optical switches, for example based on a similar concept as described in U.S. Pat. No. 6,577,430. This uses a 1×2 switch with single fiber in and 2 fiber out. The operation of this switch is based on Faraday rotator assembly in which polarization rotation can be electrically controlled between 0° and 90°, forming a base for bi-directional devices. It uses at least one single lens to coupling two fibers for compactness, Polarization splitter, a light-bending device, situated to compensate for the angle between the two light beams that share the same lens, advantageously increasing alignment tolerance, followed by polarization splitter and combiners. By applying voltage to a variable waveplate (which is electro-optic or magneto-optic) the location of the beam is shifted and hence switching objective is achieved. Now, to extend this idea, the switch is 1×N and also the input “1” of the switch is an array of fibers (say 32 fibers) and each of the N outputs are also 32 fibers. By using 8 of such switches, a switch of 256 can be performed. To achieve this the packaged parallel 1×N switch can be miniaturized for compactness and also the parallel lines can be all switched at the same time.

In an embodiment, the switches 101 are single-mode fiber switches. For single mode applications, there are several standards in terms of optical transceivers, such as 800G standards on 800G DR8 , 800 G 2×DR4 and 800G PSM8 . These three standards have similar internal architectures including 8Tx and 8 Rx with a single channel rate of 100 Gbps and require 16 fibers. Among these standards, PSM8 has a transmission distance of 100 m while DR8 and 2×DR4 corresponds to distance of 500 meters. Use of Mux and De-mux can allow multiplexing multi-wavelengths on a single fiber by dense division multiplexing (DWM) if the lasers are multi-wavelength. For instance, FR transceivers use these mux-es and de-muxes for longer reach.

As can be appreciated, the intra-rack connectivity described above can be scaled up to provide connectivity between a large number of processors, expansion memories, or other components in a given rack. Let us consider the example of scaling up intra-rack connectivity using the proposed solution with the assumption that the connectivity bandwidth is at least 1.6 TB/s (12.8 Tbps) in on direction or 3.2 TB/s both transmit and receive directions. It is desirable to interconnect a processor (or a GPU) to an many other processors or expansion memories. It is also assumed that a rack could have as little as 20 processor or as high as 64 processors or memories. In this example we assume to use multi-mode switch 1×N with switching speed of sub micro-second. We also assume that there is no mux/de-mux between switch and the laser/photo-diodes. With these assumptions, one could consider that an array of 1×N switches where 1 (the switch input) is an array of 32 channels can switch to each of the N outputs, with each output an array of 32 channels. A switching function switch the array of 32 from the input to any of the N outputs all at once, thus 8 switches together perform switching of 256 channels. Depending on the size and switch design, it could be 16 1×N switches where input and each of the outputs are array of 16, thus 16 parallel 16 channels are switched.

The number of processors or extended memories that a processor can connect to depends on the number of I/O of the switch and N. If a processor has 8 interfaces for scale-up and connectivity within a rack, then with N=4 and using these 8 scale-up interfaces, 4×8=32, processors/GPU can be connected with the connectivity throughput of 1.6 TB/s (or 3.2 TB/s for both directions of Tx and Rx). With N=9 and 8 scale-up interfaces, one can connect 9×8=72 processor/GPU or expansion memory.

In the above-described embodiments, external connections 150 between an I/O interface 7 of processor 1 and external components 151 that reside on the same IC board and/or in the same rack of processor 1 can be referred to as a scale-up connection. As can be appreciated, further scaling of connectivity can be achieved by providing connectivity between I/O interface 7 and external components 151 from on one or more other racks. Such connections can be referred to as scale-out connections. In such a configuration, a plurality of processors from different racks can be interconnected to provide a large cluster of processors.

As an example, where the processor 1 is provided on a first rack, the plurality of switches 101 of the interconnect system 100 can comprise at least one scale-out switch having a first interface coupled to one of the plurality of I/O interfaces 7 of the processor 1 and a plurality of second interfaces providing selective connectivity between the first interface and a plurality of inter-rack switches. The plurality of inter-rack switches provides connectivity to components in one or more second racks.

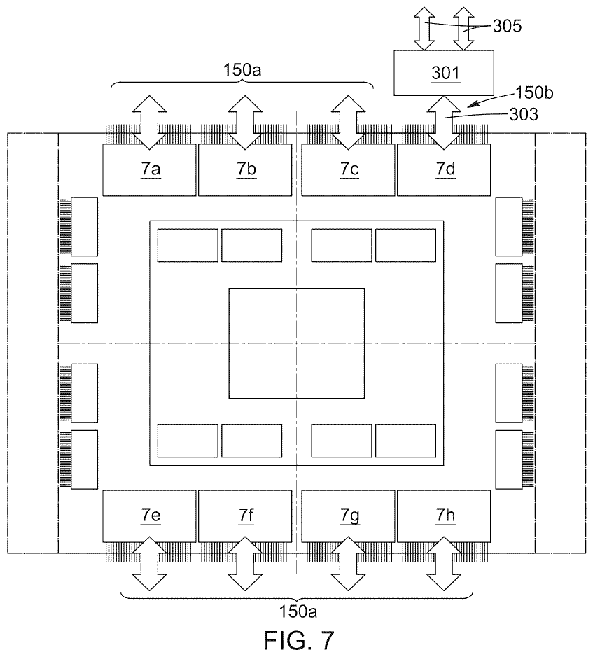

An exemplary embodiment of interconnect system 100 comprising a scale-out switch 301 is shown in FIG. 7. In the illustrated embodiment, processor 1 has a beachfront with a total of eight I/O interfaces 7a-7h for connectivity to external components. Seven of the I/O interfaces 7a-7c and 7e-7f are used for scale-up connections 150a, whereas one of the interfaces 7d is used to provide a scale-out connection 150b via scale-out switch 301. More specifically, the scale-out switch 301 is a 1×N switch having a first interface 303 coupled to I/O interface 7d, and N second interfaces 305 providing selective connectivity between the first interface 303 and an inter-rack switching fabric comprising N planes of inter-rack switching. In the illustrated embodiment, N=2 such that scale-out switch 301 is a 1×2 switch providing connectivity to two planes of inter-rack switching, but it is appreciated that other configurations are possible. It can be appreciated that the throughput for the scale-out connections 150b can be different from scale-up connections 150a due to the reach requirements. As an example, the scale-up throughput can be 256×50 G=12.8 Tbs (25.6 Tbps bi-directional) or 1.6 TB/s (3.2 TB/s bi-directional), whereas for scale-out this throughput can depend on type of transceiver that is coupled to the scale-out switch 301. The transceiver could have data rates of 200 Gbps, 400 Gbps, 800 Gbps, 1600 Gbps or 3200 or higher rates.

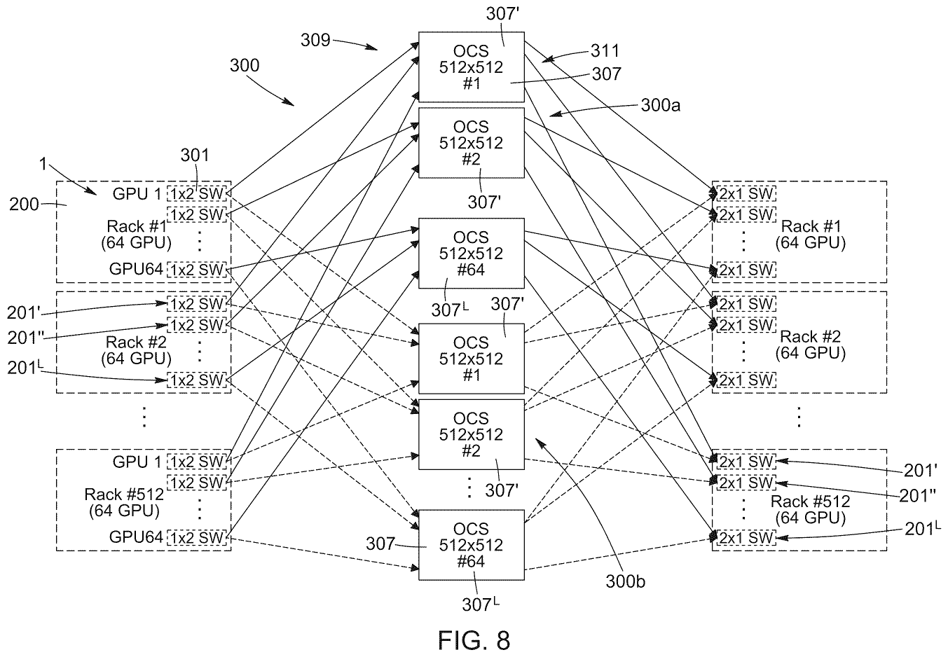

In more detail now, an exemplary embodiment of interconnect system 100 for providing interconnectivity to a plurality of processors on a plurality of racks is shown in FIG. 8. In the illustrated embodiment, there are a total of 512 racks 200, with each rack having capacity to house 64 processors 1, but it is appreciated that in other embodiments, a different number M of racks and L processors is possible. Each processor 1 has one of its I/O provided with a scale-out switch 301 to enable a scale-out connection. More specifically, the scale-out switch 301 is implemented as a 1×2 switch providing connectivity to an inter-rack switch cluster 300 comprising two planes 300a, 300b of inter-rack switching. It is appreciated, however, that the scale-out switch 301 can be configured as 1×N switch for providing connectivity to another number N of inter-rack switching planes, where N is greater than or equal to 2. As can be appreciated, providing a higher value for N can allow for alternate connection paths in case one path is blocked and/or in case a switching plane fails.

Each plane 300a, 300b of the inter-rack switching cluster 300 comprises a plurality of inter-rack switches 307, and each inter-rack switch 307 is a 512×512 switch comprising 512 first interfaces 309 and 512 second interfaces 311. The first and second interfaces 309, 311 are each coupled to a scale-out switch 301 of a processor 1 on a respective one of the 512 racks. More specifically, each first interface 309 (e.g., each input interface) of an inter-rack switch 307 is coupled to an output interface of the scale-out switch 301 of each processor 1 in a given rack. Similarly, each second interface 311 (e.g., each output interface) of can inter-rack switch 307 is coupled to an input interface of the scale-out switch 301 of each processor 1 in the given rack. The first interfaces 303 of the scale-out switches 301 are coupled to inter-rack switches 307 in the first plane 300a, and the second interface 305 of the scale-out switches 301 are coupled to inter-rack switches 307 in the second plane 300b.

The number of first and second interfaces 309, 311 of inter-rack switches 307 correspond to the number of racks 200, such that the inter-rack switches 307 can provide selective connectivity between processors in any of the 512 racks 200. It is appreciated that the inter-rack switches 307 can be configured as M×M switches (i.e., comprising M first interfaces and M second interfaces) for providing connectivity between any number M of racks as required.

In the illustrated embodiment, 64 inter-rack switches 307 are provided in each of the switching planes 300a, 300b. The number of inter-rack switches 307 corresponds to the processor capacity of each rack 200, such that connectivity can be provided to each processor 1 in a given rack 200. It is appreciated that any number L of inter-rack switches 307 can be provided according to the processor capacity L of each rack 200.

In the illustrated configuration, in each switching plane 300a, 300b, processors in a first slot 201′ of each rack 200 are coupled to a first inter-rack switch 307′, processors in a second slot 201″ of each rack 200 are coupled to a second inter-rank switch 307″, and this continued for an Lth sloth 201^{L} of each rack 200 coupled to an Lth inter-rack switch 307^{L}. It is appreciated, however, that a different organization of the connections are possible.

In the above-described configuration, the number of processors (e.g., GPUs) can be scaled to 32,000. More specifically, each rack has 64 GPUs and, with one interface per GPU being use for scale-out, there are 64 interfaces that can be used for scale-out in each rack. With 512 racks, and with each rack being connected to all 64 inter-rack switches through the 64 interfaces of all 64 GPUs, the total number of interconnected GPUs is 64×512=32,768 GPUs. It is appreciated that further scaling can be achieved via different numbers of racks and different rack capacities, and corresponding switches.

In the present embodiment, the scale-out switches 301 are implemented as fast photonic switches capable of sub-microsecond switching, whereas the inter-rack switches 307 are implemented as slow optical circuit (OCS) switches with switching speeds of multiple milliseconds. Though the inter-rack switches 307 are slow, fast sub-microsecond switching for end-to-end connectivity through the switch cluster 300 can be achieved by operating the scale-out switches 301 in conjunction with the inter-rack switches 307 according to a method that involves setting up a connection path in an alternate plane of switch cluster 300 before rapidly switching the connection not the alternate plane via scale-out switches 301.

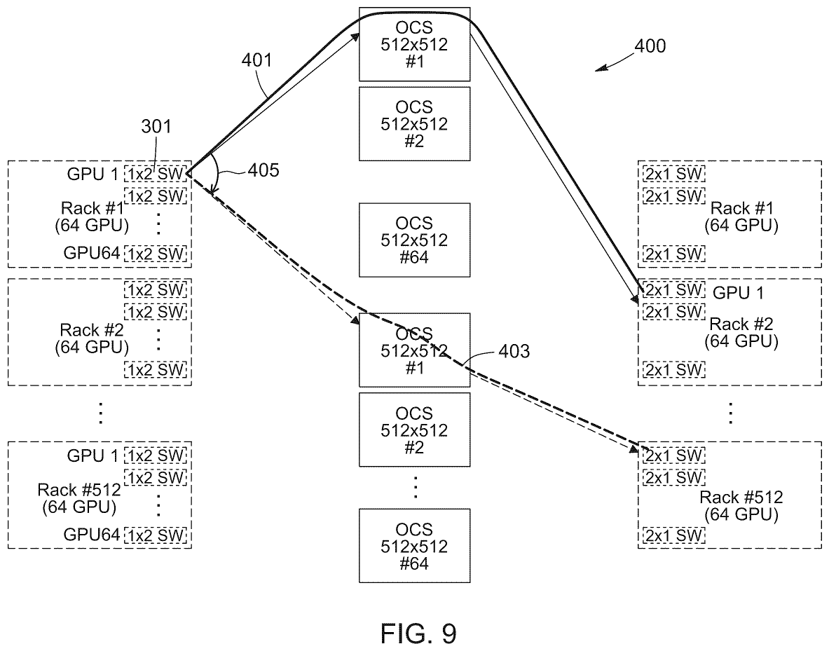

An exemplary method 400 for establishing a connection between a first processor provided on a first rack and a second processor provided on a second rack via the above-described inter-rack switch cluster comprising N planes of inter-rack switching is illustrated in FIG. 9. The method 400 can apply, for example, where there is an existing connection between the first processor and another processor. For example, as illustrated by pathway 401, we can consider that there is an existing connection between GPU1 of Rack1, and GPU1 of Rack2. This connection uses the upper port of the 1×2 scale-out switch 301 that is coupled to GPU1 of Rack1 (i.e., in the first plane 300a).

If the first processor needs to be connected to a second processor, an inter-rack switch 307 in one of the planes 300a, 300b can be operated to preestablish a connection path between the first processor and the second processor. For example, if a next task needs GPU1 of Rack1 to be connected to GPU1 of Rack512, a connection 403 can be preestablished through an alternate second plane (i.e., the second plane 300b) through the bottom output port of the 1×2 scale-out switch 301 that is coupled to GPU1 of Rack1. This connection 403 can be established in a few milliseconds (such as 10s of milliseconds).

Once the connection path has stabilized, a scale-out switch 301 coupled to the first processor can be operated to connect the first processor to the connection path in the one of the planes 300a, 300b. For example, once the communication between GPU1 of Rack1 and GPU1 of Rack2 is no longer needed (i.e., when a corresponding processing task is complete), the scale-out switch 301 coupled to GPU1 of Rack1 can be switched 405 in sub-microsecond speed to its bottom output port (i.e., to the second plane 300b) to enable connectivity to GPU1 of Rack 512.

As can be appreciated, where more inter-rack switching planes are provided (e.g., N>2), there will be more available potions for preestablishing connections and avoiding blockages caused by connection paths that are already in use. In such configurations, a connection can be preestablished in any available one of N-1 standby planes before switching the connection to that plane.

It is clear that a person skilled in the art can make various modifications and variations to this application without departing from the scope of this disclosure. This disclosure is intended to cover these modifications and variations of this application provided that they fall within the scope of protection defined by the following claims and their equivalent technologies.

1. An interconnect system for a processor comprising a plurality of input/output (I/O) interfaces, the interconnect system comprising a plurality of switches, each of the plurality of switches having a first interface coupled to one of the plurality of I/O interfaces and N second interfaces providing selective connectivity between the first interface and N external connections.

2. The interconnect system of claim 1, wherein the plurality of switches comprises:
a plurality of 1×N switches each providing connectivity in a transmit direction between one output interface of the processor and the N external connections; and
a plurality of N×1 switches each providing connectivity in a receive direction between the N external connections and one input interface of the processor.

3. The interconnect system of claim 1, wherein the plurality of I/O interfaces each comprise an array of I channels, further wherein the plurality of switches is operable to switch all I channels of the I/O interface to I corresponding channels of a selected one of the N external connections.

4. The interconnect system of claim 1, wherein at least one of the plurality of switches is a copper-based lane switch.

5. The interconnect system of claim 1, wherein at least one of the plurality of switches is a multi-mode fiber-based switch or a single mode fiber-based switch.

6. The interconnect system of claim 5, wherein the plurality of switches is bi-directional providing connectivity in both a transmit direction and a receive direction between the one of the plurality of I/O interfaces and the N external connections.

7. The interconnect system of claim 1, wherein the N external connections comprise connections to components external to the processor comprising at least one of: memory modules, other processors, and switches coupled to memory modules and/or other processors.

8. The interconnect system of claim 7, wherein the processor is provided on an integrated circuit (IC) board, and at least some of the external components are also provided on the IC board.

9. The interconnect system of claim 7, wherein the processor is provided on a first IC board, and at least some of the external components are provided on one or more second IC boards.

10. The interconnect system of claim 9, wherein the first IC board is provided in a first slot of a rack, and the one or more second IC boards are provided in respective second slots of the rack.

11. The interconnect system of claim 1, wherein the processor is provided on an IC board, and the plurality of switches are also provided on the IC board.

12. The interconnect system of claim 11, wherein the IC board is provided in a first slot of a rack, and the N external connections comprise connections to external components in respective second slots of the rack.

13. The interconnect system of claim 1, wherein the processor is provided on a first IC board, and the plurality of switches are provided on one or more second IC boards.

14. The interconnect system of claim 13, wherein the first IC board is provided in a first slot of a rack, and the one or more second IC boards are provided in respective second slots of the rack.

15. The interconnect system of claim 1, wherein the processor is provided in a first rack, the interconnect system comprising at least one scale-out switch having a first interface coupled to one of the plurality of I/O interfaces and a plurality of second interfaces providing selective connectivity between the first interface and a plurality of inter-rack switches, the plurality of inter-rack switches providing connectivity to components in one or more second racks.

16. An interconnect system for a plurality of processors provided on M racks, the interconnect system comprising:
a plurality of scale-out switches, each scale-out switch having a first interface coupled to an I/O interface of one of the plurality of processors and N second interfaces providing selective connectivity to N planes of inter-rack switching; and
an inter-rack switch cluster comprising the N planes of inter-rack switching, each plane comprising a plurality of inter-rack switches, each inter-rack switch comprising M first interfaces and M second interfaces each coupled to a scale-out switch of a processor on a respective one of the M racks.

17. The interconnect system of claim 16, wherein each rack has a capacity of L processors, and each plane of the inter-rack switching comprises L inter-rack switches.

18. The interconnect system of claim 16, wherein the plurality of scale-out switches are fast photonic switches, and the plurality of inter-rack switches are slow optical circuit (OCS) switches.

19. The interconnect system of claim 16, wherein N is greater than or equal to 2.

20. A method for establishing a connection between a first processor provided on a first rack and a second processor provided on a second rack via an inter-rack switch cluster comprising N planes of inter-rack switching, the method comprising:
operating an inter-rack switch in one of the N planes to preestablish a connection path between the first processor and the second processor; and
once the connection path has stabilized, operating a scale-out switch coupled to the first processor to connect the first processor to the connection path in the one of the N planes.
